(19) United States
(12) Patent Application Publication
(10) Pub. No.: US 2024/0395041 A1
(43) Pub. Date: Nov. 28, 2024

(54) REPRESENTATIVE FRAME SELECTION FOR VIDEO SEGMENT

(71) Applicant: Hewlett-Packard Development Company, L.P., Spring, TX (US)

(72) Inventors: Guillaume Gerardin, Boise, ID (US); Gabriel Scott McDaniel, Boise, ID (US); Ella Brucker, Boise, ID (US); Elizabeth Swanson, Boise, ID (US); Jeffrey Luke, Boise, ID (US); Paul L. Jeran, Boise, ID (US)

(21) Appl. No.: 18/202,932

(22) Filed: May 28, 2023

(51) Int. Cl. G06V 20/40; G06V 10/762; G06V 40/16

(52) U.S. Cl. CPC G06V 20/47; G06V 10/762; G06V 20/41; G06V 40/174

(57) ABSTRACT

Preliminary frames are selected from a video segment. For each preliminary frame, an emotion present in the preliminary frame and an emotional intensity of the emotion present in the preliminary frame are identified using a machine learning model. One or more candidate frames are selected from the preliminary frames having the emotion that is present in the greatest number of the preliminary frames. One or more representative frames for the video segment are selected from the candidate frames based on the emotional intensity thereof.

### BACKGROUND

Traditionally, electronic information has been static, in the form of text and images. The state nature of the electronic information permitted users to easily print hardcopies using printing devices. However, electronic information is now often dynamic, such as in the form of video. For example, users may participate in video conferences and electronic meetings, which may be recorded for later viewing. Video recorded professionally as well as by amateurs have also become a popular way to disseminate information, such as via video-sharing platforms.

### BRIEF DESCRIPTION OF THE DRAWINGS

FIG. 1 is a diagram of an example process for selecting a representative frame for a video segment.

FIG. 2 is a flowchart of an example method for selecting preliminary frames of a video segment.

FIGS. 3A, 3B, 3C, and 3D are diagrams depicting example selection of preliminary frames of a video segment using the method of FIG. 2.

FIG. 4 is a flowchart of another example method for selecting preliminary frames of a video segment.

FIG. 5 is a diagram depicting example selection of preliminary frames of a video segment using the method of FIG. 4.

FIG. 6 is a flowchart of an example method for modifying the set of preliminary frames of a video segment after they have been selected.

FIG. 7 is a diagram depicting example modification of a set of preliminary frames of a video segment after they have been selected, using the method of FIG. 6.

FIG. 8 is a flowchart of an example method for selecting one of the representative frames of a video segment.

FIG. 9 is a diagram of an example summarization of a video, including individual summarizations of segments of the video having respective representative frames.

FIG. 10 is a diagram of an example computing device.

### DETAILED DESCRIPTION

As noted in the background, electronic information is often dynamic, such as in the form of video. Such video can include recorded live presentations and video conferences, and video that is professionally recorded or recorded by amateurs for dissemination without prior live presentation or participation. Video often includes facial images of presenters, as well as other users such as audience members and video conference participants. In comparison with static forms of electronic information, video and other types of dynamic electronic information are more difficult to print hardcopies of. A user wishing to quickly review a video to discern the information contained therein may have to skip through the video, which may result in the user missing key information, or have to play back the video at a fast playback speed, which can be difficult to understand, and requires additional time and effort.

Therefore, a summarization may be generated for a video in which there are individual summarizations for different segments of the video. Different techniques may be used to identify segments of the video that correspond to different topics. For each video segment, text summarizing the segment may be generated and displayed within the summarization of the segment, along with a representative frame of the video for the segment. The summarization itself is in non-video form, such as a static document having one or more multiple pages, lending itself to more convenient review by users to discern the information contained in the video without viewing the video itself. Hardcopies of the non-video summarization may be printed, for instance.

Video summarization techniques may require a user to manually identify a representative frame for each video segment, even if the techniques are able to segment the video into segments and generate text summarizing each segment automatically. Techniques that automatically select one or more representative frames of a video segment without user involvement are a type of image processing require the utilization of computers and do not merely automate what users can perform themselves. That is, while a user may be able to manually select a representative frame for a video segment, automatic selection techniques do not automate the manual selection process that the user performs, but rather select representative frames in a different way.

Such automatic techniques cannot be performed by a user manually, because the type of image processing that they perform, which may leverage machine learning, are intractable without the utilization of a computer. Stated another way, representative frame selection techniques are necessarily a computing-oriented technology. Such techniques that select representative frames for a video segment that are more indicative of the content of that segment constitute a technological improvement. To the extent that the techniques employ image processing and/or machine learning, the techniques do not use such processing and/or machine learning in furtherance of an abstract idea, but rather to provide a practical application, namely the improvement of an underlying technology.

Described herein are techniques for selecting representative frames for a video segment that have been found to identify such frames that are more indicative of the content contained within the segment as compared to existing techniques. The techniques leverage image processing and machine learning to select representative frames for a video segment, such that their manual performance-without the utilization of computers—is intractable. When multiple representative frames are identified, though, a user may select which representative frame ultimately is used to summarize the video segment within the summarization of the video of which the segment is a part.

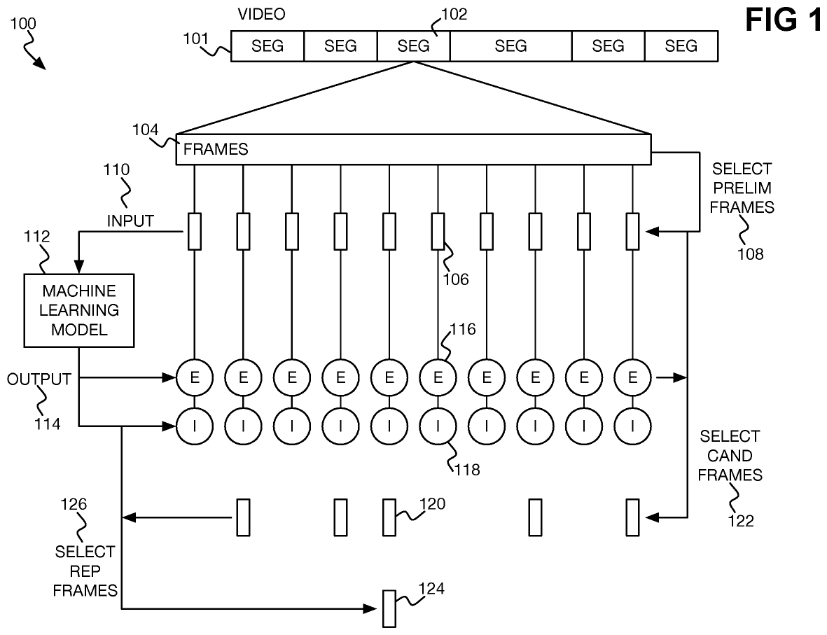

FIG. 1 illustratively depicts an example process 100 for selecting a representative frame 124 of a segment 102 of a video 101. The video 101 has multiple such segments 102, and each segment 102 may have a respective representative frame 124 selected in accordance with the described process 100. The video segments 102 may be contiguously adjacent, such that from the first frame of the video 101 to the last frame, the frames are segmented into contiguous segments 102. Each segment 102 may correspond to a separate topic of the video 101, where more than one non-adjacent segment 102 may correspond to the same topic if an intervening segment or segments 102 correspond to different topics. Each segment 102 includes a number of frames 104 of the video 101 that correspond to the segment 102 in question.

Preliminary frames 106 of a video segment 102 are selected (108) from the frames 104 of the video 101. The frames 104 of the video segment 102 may be sampled to select the preliminary frames 106, or the preliminary frames 106 may be otherwise selected from all the frames 104 of the segment 102. Once the set of preliminary frames 106 for the segment 102 have been selected, preliminary frames 106 may individually be replaced with other frames 104 to ensure that the preliminary frames 106 represent a diverse cross-section of the different frames 104 of the segment 102. Different techniques for selecting the preliminary frames 106 and subsequently adjusting which frames 104 are used as the preliminary frames 106 are described later in the detailed description.

Each preliminary frame 106 is individually input (110) into a machine learning model 112, which outputs (114) the emotion 116 (identified by “E” in the figure) most present in that preliminary frame 106 and the intensity 118 (identified by “I” in the figure) of that emotion 116. Stated another way, the machine learning model 112 is used and individually applied to the preliminary frames 106 to identify respective emotions 116 present in the frames 106 and the intensities 118 thereof. Each preliminary frame 106 thus has a corresponding emotion 116 that is most present in the frame 106, and an intensity 118 at which that emotion is present in the frame 106.

In one implementation, a convolutional neural network (CNN) can be used as the machine learning model 112 to identify the emotion 116 and the intensity 118 of that emotion 116 in each preliminary frame 106. A publicly available dataset or a proprietary set of curated images may be employed to train the machine learning model 112. For example, each training image may be a facial image that has been manually or otherwise labeled with the emotion most exhibited by the face within the image. The labeled images may be divided into a set of training images and a set of testing images, where the former is used to train the model 112 and the latter is used to test the accuracy of the model 112. As an example of a publicly available dataset, the facial expression recognition and analysis (FERA) dataset includes facial images that are each labeled with one of seven emotions: anger, disgust, fear, neutral, sadness, and surprise.

In one implementation, the machine learning model 112 used to identify the emotion 116 most present in each preliminary frame 106 may be different than that used to identify the emotional intensity 118 of that emotion 116. In either case, the emotional intensity 118 may utilize image features such as the extent to which the mouth is open in the face of an image, the curvature of the lips in the facial image, the extent to which the eyebrows are raised in the image, and so on. A high-level, general-purpose programming language environment, such as that of Python, may be employed to build (i.e., train) the machine learning model 112, such as by using different libraries including the Keras, TensorFlow, and/or PyTorth libraries.

Candidate frames 120 are selected (122) from the preliminary frames 108 based on the emotion 116 present in the greatest number of the preliminary frames 108. That is, the preliminary frames 108 that each have the emotion 116 most present in the greatest number of the frames 108 are selected as the candidate frames 120. For example, if X frames 108 have surprise as the emotion 116 most present, if Y<X frames 108 have fear as the emotion 116 most present, and if the remaining Z<Y frames 108 have neutral as the emotion 116 most present, then the X frames 106 have surprise as their emotion 116 are selected as the candidate frames 120.

At least one representative frame 124 is then selected (126) from the candidate frames 120 based on the intensities 118 at which the common emotion 116 is present in the frames 120. The intensity 118 of a candidate frame 120 is the intensity at which the emotion 116 most present in the frame 120 is expressed therein. The intensities 118 may be expressed as a number, such as between zero, corresponding to minimum intensity at which the emotion 116 is present, and one, corresponding to maximum intensity at which the emotion 116 is present.

In one implementation, a threshold is used to select which candidate frames 120 are representative frames 124. Each candidate frame 120 for which the intensity 118 is greater than the threshold is thus selected as a representative frame 124. In another implementation, a number or a percentage of the candidate frames 120 having the highest intensities 118 are selected as the representative frames 124. For example, a threshold number or a threshold percentage of the candidate frames 120 that have the highest intensities 118 are selected as the representative frames 124.

The selected representative frames 124 can be used to summarize the video segment 102 within an overall summarization of the video 101, an example of which is described later in the detailed description. If more than one representative frame 124 or if too many frames 124 have been selected, the representative frames 124 may be culled to a single frame 124 or a smaller number of frames 124. For example, the selected representative frames 124 may be displayed to a user for selection of which frame(s) 124 to use to summarize the segment 102, as described in detail later in the detailed description.

The described representative frame selection process 100 does not simply automate manual user selection of the representative frame 124 for a video segment 102. If a user were to manually select the frame 124, they would simply view the segment 102 and select which frame 124 best conveys the information contained in the segment 102. Furthermore, the process 100 is an image processing technique, and thus is an improvement of image processing technology, insofar as it performs preliminary frame selection, which can include analyzing individual frames 104 of the segment 102, and insofar as it employs a machine learning model 112 to identify the emotion 116 and the intensity 118 for each preliminary frame 106.

The process 100 can further be considered a digital content generation process, which is also a technology that is therefore improved. The process 100 does not select frames 108, 120, and 124 for the sake of identifying these frames 108, 122, and 124, and similarly does not identify the emotions 116 and the intensities 118 for the sake of identifying the emotions 116 and the intensities 118. Rather, the process 100 selects frames 108, 120, and 124 and identifies the emotions 116 and the intensities 118 as part of a content generation process that uses one or more of the ultimately selected representative frames 124 to at least partially summarize a segment 102 within a non-video summarization of the video 101 including that segment 102.

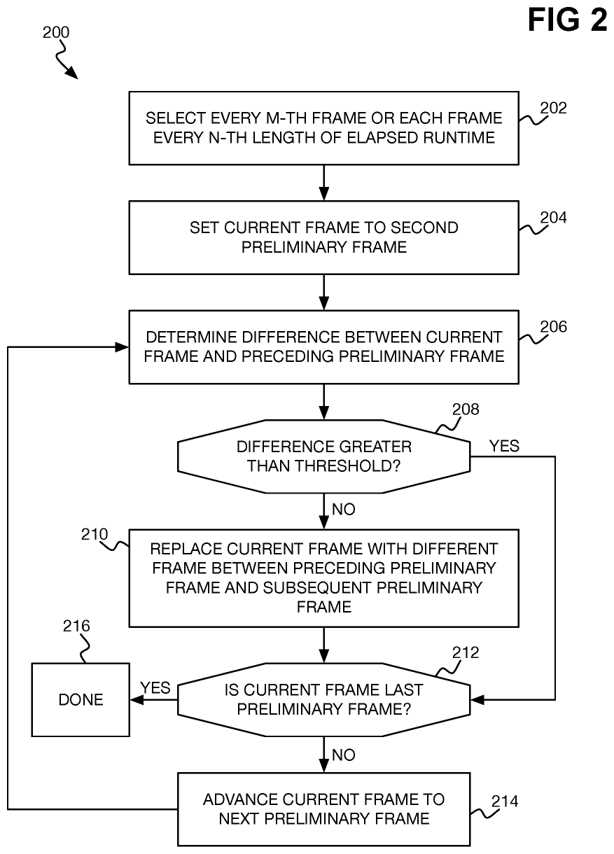

FIG. 2 shows an example method 200 for selecting preliminary frames 106 from the frames 104 of a video segment 102 of a video 101 in the process 100. The method 200 include selecting every m-th frame 104 or each frame 104 every n-th length of elapsed runtime of the segment 102, as one of the preliminary frames 106 (202). For example, every 30th frame 104 may be selected as a preliminary frame 106, or each frame 104 every five seconds may be selected as a preliminary frame 106. Such frame intervals can be specified in either way, for instance, in the OpenCV library of computer vision programming functions.

The set of preliminary frames 106 may then be adjusted to ensure that the frames 106 are sufficiently different from one another and reflect the diversity of the frames 104 from which they were selected. A given preliminary frame 106 may be replaced with a different frame 104 of the video segment 102. The preliminary frames 106 are ordered from a first preliminary frame 106 that temporally appears in the segment 102 first to a last preliminary frame 106 that temporally appears in the segment 102 last.

The method 200 can thus include setting a current frame to the second preliminary frame 106 (204), which temporally is the preliminary frame 106 appearing next after the first preliminary frame 106 within the segment 102. The difference between the current frame and the immediately preceding preliminary frame 106 is determined (206). This difference may be determined in a number of different ways. Each of the current frame and the preceding preliminary frame 106 is an image, and therefore a sum of squares approach, a cross-correlation approach, or another approach that determines the similarity between two images can be used to determine the difference. If the difference is not greater than a threshold (208), then the current frame is replaced with a different frame 104 (210).

That is, rather than using the current frame as a preliminary frame 106, a different frame 104 is used. Therefore, if the current frame does not differ from the preceding preliminary frame 106 by more than the threshold, the current frame is too similar to the preceding preliminary frame 106 to constitute a preliminary frame 106 itself, and the current frame is replaced with one that differs more from the preceding preliminary frame 106. In one implementation, the current frame is replaced with a different frame 104 between the immediately preceding and subsequent preliminary frames 106 that differs from the preceding preliminary frame 106 by more than the threshold. In the case in which the current frame is the last preliminary frame 106, it is replaced with a different frame 104 between the immediately preceding preliminary frame 106 and the last frame 104 of the segment 102.

For example, starting from the current frame, the frames 104 before and after the current frame may be alternatingly considered with increasing distance from the current frame until a frame 104 is identified that differs from the preliminary frame 106 by more than the threshold. If during this process the preceding or subsequent preliminary frame 106 is reached without identifying such a different frame 104, then the current frame may be removed (as opposed to being replaced) as a preliminary frame 106. Another approach may also be used to identify a different frame 104 that differs more from the preceding preliminary frame 106 to replace the current frame as a preliminary frame 106.

Once the current frame has been replaced with a different frame 104 (210) or if the current frame is initially determined to sufficiently differ from the preceding preliminary frame 106 (208), and if the current frame is not the last preliminary frame 106 (212), the method 200 proceeds to advance the current frame to the next preliminary frame 214 that has been selected in the video segment 102 (214). The method 200 then repeats at 206 with the new current frame. Once the last preliminary frame 214 has been processed (212), the method 200 is finished (216). To the extent that any selected preliminary frame 214 has been replaced by a different frame 104, the resulting set of preliminary frames 214 is more diverse and better reflects the frames 104 of the segment 102.

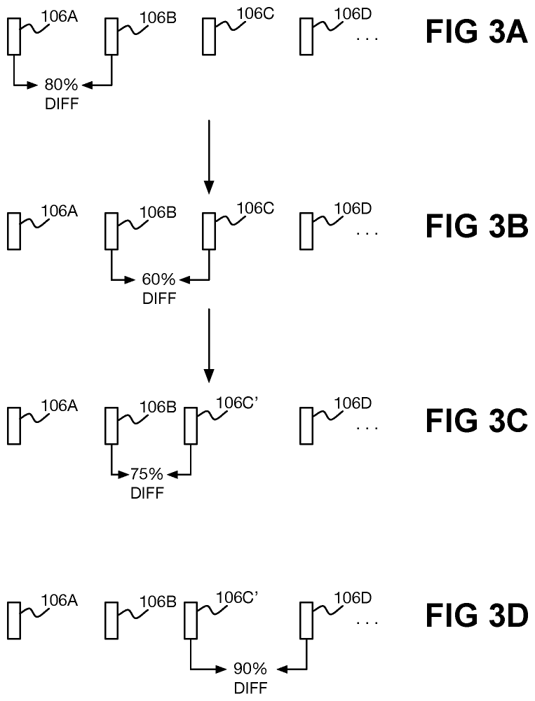

FIGS. 3A, 3B, 3C, and 3D illustratively depict example performance of the method 200. Per FIG. 3A, there are initially selected preliminary frames 106A, 106B, 106C, 106D, . . . . The current frame is set to the second preliminary frame 106B, and a difference between the second preliminary frame 106B and the immediately prior preliminary frame 106A (i.e., the first preliminary frame 106) is determined. In the example, the difference between the frames 106A and 106B is 80%. Assuming a threshold of 70%, the frames 106A and 106B are considered sufficiently different that the preliminary frame 106B is not replaced.

Per FIG. 3B, the current frame is then set to the third preliminary frame 106C, and a difference between the third preliminary frame 106C and the immediately prior preliminary frame 106B (i.e., the second preliminary frame 106) is determined. In the example, the difference between the frames 106B and 106C is 60%. In view of the threshold of 70%, the frames 106B and 106C are considered too similar, and therefore the preliminary frame 106C is replaced with a different frame 104.

Per FIG. 3C, starting at the third preliminary frame 106C, the frames 104 before and after the preliminary frame 106C are individually considered until a different frame 104 is identified that differs from the preceding preliminary frame 106B by more than the threshold. The third preliminary frame 106C is thus replaced with the different frame 104 identified as the new third preliminary frame 106C′, which differs from the preceding immediately preceding preliminary frame 106B by 75% in the example. The frame 106C is no longer considered a preliminary frame, and rather the preliminary frame 106C′ takes its place.

Per FIG. 3C, the current frame is set to the fourth preliminary frame 106D, and a difference between the fourth preliminary frame 106D and the immediately prior preliminary frame—which is now the new third preliminary frame 106C′—is determined. In the example, the difference between the preliminary frames 106C′ and 106D is 90%. In the case in which the threshold is 70%, the frames 106C′ and 106D are sufficiently different from one another, and therefore the preliminary frame 106D is not replaced with a different frame 104.

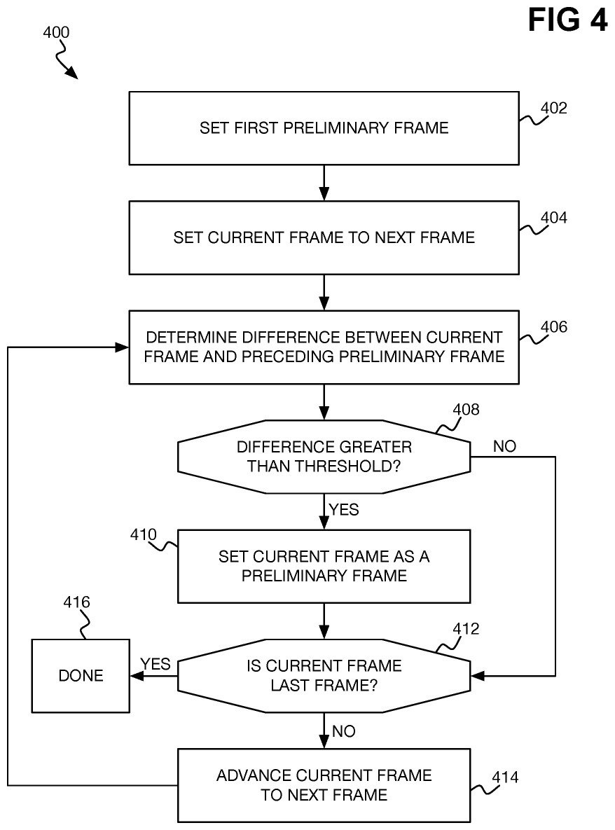

FIG. 4 shows another example method 400 for selecting preliminary frames 106 from the frames 104 of a video segment 102 of a video 101 in the process 100. The method 400 includes setting one of the frames 104 as the first preliminary frame 106 (402). For example, the first frame 104 of the segment 102 may be set as the first preliminary frame 106, the m-th frame 104 of the segment 102 may be set as the first preliminary frame 106, or the frame 104 at an n-th length of elapsed runtime of the segment 102 may be set as the first preliminary frame 106.

The method 400 includes then setting a current frame to the next frame 104 within the video segment 102 after the first preliminary frame 106 (404). A difference between the current frame and the preceding preliminary frame 106 is determined (406), as has been described in relation to the method 200. If the difference is greater than a threshold (408), then the current frame is set as another preliminary frame 106 (410).

Once the current frame has been set as a preliminary frame 106 (410) or if the difference between the current frame and the preceding preliminary frame 106 is not greater than the threshold (412), and if the current frame is not the last frame 104 within the video segment 102 (412), the method 400 proceeds to advance the current frame to the next frame 104 within the segment 102 following the current frame (414). The method 400 then repeats at 406 with the new current frame. Once the last frame 104 within the segment 102 has been considered (412), the method 400 is finished (416).

The method 400 therefore selects frames 104, from the first frame 104 through the last frame 104, as preliminary frames 106 when they differ from an immediately prior preliminary frame 106 by more than a threshold. If an insufficient number of preliminary frames 106 have been selected, the method 400 can be repeated with a lower threshold. If too many preliminary frames 106 have been selected, the method 400 can be repeated with a higher threshold.

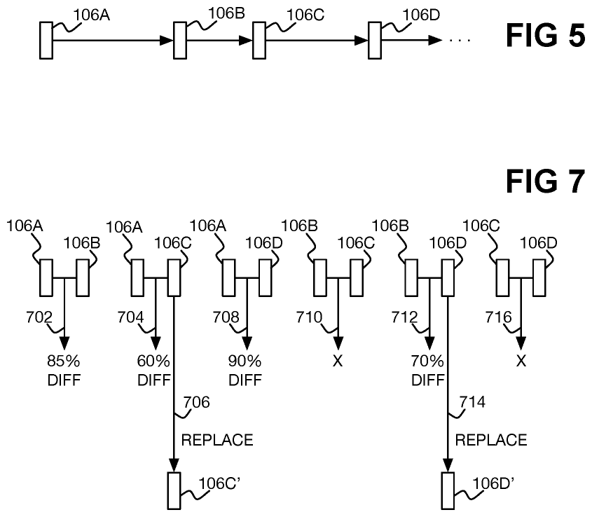

FIG. 5 illustratively depicts example performance of the method 400. A frame 104 of the video segment 102 is selected as the first preliminary frame 106A. Thereafter, the frames 104 are considered in order from the first preliminary frame 106A until a frame 104 is identified that differs from the first preliminary frame 106A by more than a threshold, which is set as the second preliminary frame 106B. The frames 104 starting from the second preliminary frame 106B are considered until a frame 104 is identified that differs from the second preliminary frame 106B by more than a threshold, which is set as the third preliminary frame 106C. The frames 104 starting from the third preliminary frame 106C are considered until a frame 104 is identified that differs from the third preliminary frame 106C by more than a threshold, which is set as the fourth preliminary frame 106D. This process is repeated until the last frame 104 of the segment 102 has been reached.

The method 400 differs from the method 200 in that the preliminary frames 106 selected in the method 400 are likely not to be regularly sampled frames 104 of the video segment 102, whereas the preliminary frames 106 initially selected in the method 200 are regularly sampled frames 104 of the segment 102. That is, in the method 200, the frames 104 are initially sampled in a regular manner, such as by selecting every m-th frame 104 or each frame 104 every n-th length of elapsed run time. The initially selected preliminary frames 106 may then be individually replaced if adjacent preliminary frames 106 are not sufficiently different from one another. By comparison, in the method 400, the preliminary frames 106 are initially selected in such a way that adjacent preliminary frames 106 are sufficiently different from one another.

FIG. 6 shows an example method 600 for modifying the set of preliminary frames 106 of a video segment 102 after they have been selected. The preliminary frames 106 may be selected by using at least a portion of the method 200 (i.e., with or without the subsequent modification of the method 200), or by using the method 400. The method 600 provides another way to ensure that preliminary frames 106 are sufficiently different from one another, and reflect the diversity of the frames 104 of the segment 102.

The method 600 includes clustering the preliminary frames 106 into clusters by their similarity (602). For example, K-means clustering may be performed on the preliminary frames 106 in consideration of the pixel values of each frame 106. The pixel values of each preliminary frame 106 in this case may be converted into vector form to generate vectors of the frames 106 that are used in such K-means clustering, or another clustering technique that is vector-based. If the number of clusters is not less than a threshold (606), then this can mean that the preliminary frames 106 are sufficiently different from one another that it is unnecessary to replace any of the frames 106. In this case, the method 600 is terminated (604).

If the number of clusters in which the preliminary frames 106 have been clustered is less than a threshold (606), then this can mean that the frames 106 are not sufficiently different from one another. For example, if there are 100 preliminary frames 106 clustered into five clusters, such that the frames 106 in each cluster are similar to one another, then this can mean that there are just five groups (i.e., clusters) of frames 106 that are sufficiently different from one another. Such a small number of groups of similar preliminary frames 106 may not reflect the full diversity of different frames 104 of the video segment 102.

Therefore, some of the preliminary frames 106 are replaced with other frames 104 of the video segment 102. In one implementation, this can be performed by the method 600 selecting the cluster having the largest number of preliminary frames 106 (608), such that one or more frames 106 within this cluster are replaced with other frames 104. In particular, each unique pair of preliminary frames 106 in the selected cluster is identified (610). For example, if the cluster includes four preliminary frames 106A, 106B, 106C, and 106D, then there are six unique pairs: frames 106A and 106B; frames 106A and 106C; frames 106A and 106D; frames 106B and 106C; frames 106B and 106D; and frames 106C and 106D.

The method 600 includes setting a current pair to the first unique pair of preliminary frames 106 within the selected cluster (612). If the preliminary frames 106 of the current pair are still in the cluster (i.e., they have not been removed from the cluster) (614), then the method 600 includes determining the difference between the frames 106 (616), as has been described in relation to the method 200. If the difference between the preliminary frames 106 of the current pair is not greater than a threshold (618), then one of the preliminary frames 106 of the current pair is removed from the cluster, and is replaced with a different frame 104 (620). That is, in addition to being removed from the cluster, one of the preliminary frames 106 is no longer considered a preliminary frame 106, and instead is replaced with a different frame 104 that becomes a new preliminary frame 106. The different frame 104 may be selected as has been described in relation to the method 200.

In the case in which the preliminary frames 106 of the current pair are not still both in the selected cluster (614) or if they are but the difference between the two frames 106 is greater than a threshold (618), and if the current pair is not the last unique pair of preliminary frames 106 in the selected cluster (622), the method 600 proceeds to advance the current pair to the next unique pair of preliminary frames 106 in the selected cluster (624). The method 600 then repeats at 614 with the new current pair. Once the last pair has been processed (622), the method 600 is finished (626).

The method 600 thus considers the similarity of the preliminary frames 106 as a whole, as opposed to considering just the similarity of adjacent preliminary frames 106 as in the method 400 and in a portion of the method 200. The clustering of the preliminary frames 106 in the method 600 does not consider the order in which the preliminary frames 106 appear in the video segment 102, whereas the method 400 and a portion of the method 200 do consider the order in which the preliminary frames 106 appear insofar as just adjacent preliminary frames 106 are compared to one another. Performing the method 600 after at least a portion of the method 200 or after the method 400 has been performed can therefore ensure that the resulting preliminary frames 106 are sufficiently different from one another.

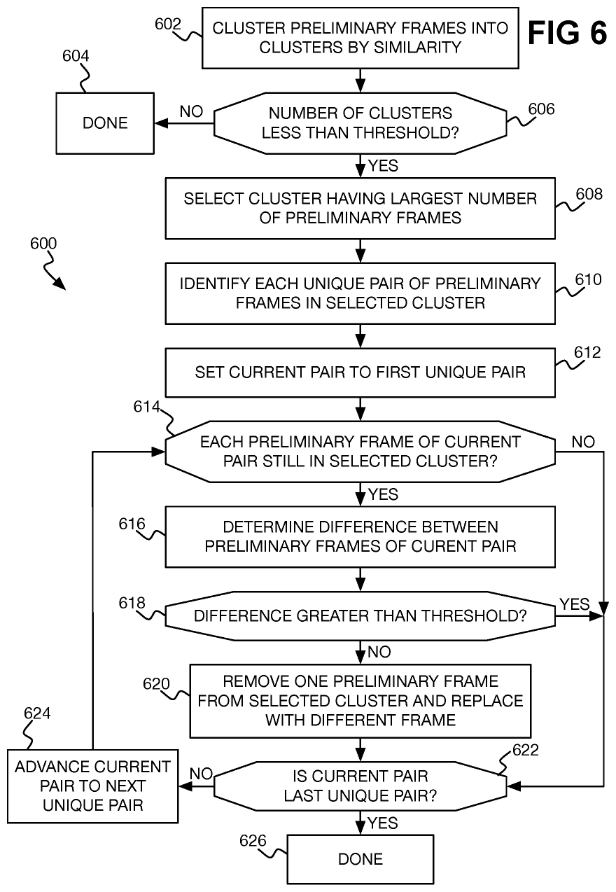

FIG. 7 illustratively depicts example performance of the method 600 as to four preliminary frames 106 that have been clustered in the same cluster. There are six unique pairs of preliminary frames 106: the frames 106A and 106B; the frames 106A and 106C; the frames 106A and 106D; the frames 106B and 106C; the frames 106B and 106D; and the frames 106C and 106D. The difference 702 between the frames 106A and 106B of the first unique pair is 85%. Against an example threshold of 75%, the preliminary frames 106A and 106B are sufficiently different from one another, and therefore neither frame 106A nor 106B is replaced as a preliminary frame 106.

By comparison, the difference 704 between the frames 106A and 106C of the second unique pair is 60%, which is lower than the threshold of 75%. In the example, the later-appearing preliminary frame 106 of a pair is therefore replaced, which as to the second unique pair is the frame 106C. Therefore, the preliminary frame 106C is replaced (706) with a different frame 104, which becomes a new preliminary frame 106C′. The preliminary frame 106C is removed from the cluster, but the new preliminary frame 106C′ is not added to the cluster.

The difference 708 between the frames 106A and 106D of the third unique pair is 90%, which is greater than the 75% threshold, and therefore neither frame 106A nor 106D is replaced as a preliminary frame 106. As to the fourth unique pair of the preliminary frames 106B and 106C, the frame 106C has been removed from the cluster, and therefore the difference 710 between the frames 106B and 106C is not calculated, as represented by an X in the figure. The preliminary frame 106B is accordingly not removed from the cluster, and is not replaced with a different frame 104.

The difference 712 between the frames 106B and 106D of the fifth unique pair is 70%, which is lower than the 75% threshold. Therefore, the preliminary frame 106D is replaced (714) with a different frame, which becomes a new preliminary frame 106D′. The preliminary frame 106D is removed from the cluster, but the new preliminary frame 106D′ is not added to the cluster. Finally, the difference 716 between the frames 106C and 106D of the last unique pair is not considered, as represented by an X in the figure, because the frame 106C has been removed from the cluster.

In the process 100, more than one representative frame 124 may be selected from the candidate frames 120. The summarization of the video segment 102 within the overall summarization of the video 101 may only have sufficient space for one such representative frame 124. In this case, therefore, one representative frame 124 is selected to use to summarize the segment 102 within the summarization of the video 101.

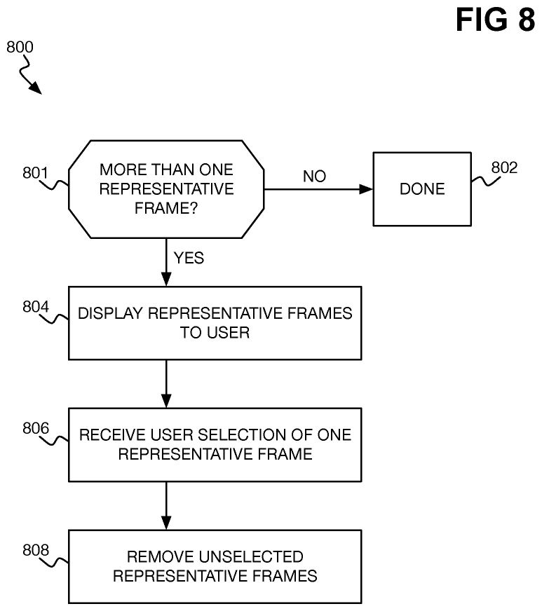

FIG. 8 shows an example method 800 for selecting which representative frame 124 is used to summarize the video segment 102 within the overall summarization of the video 101. If there is not more than one representative frame 124 (801), then the method 800 is terminated (802). If there is more than one representative frame 124 (801), however, then the method 800 includes displaying all the representative frames 124 (804), and receiving user selection of one of the representative frames 124 (806). The unselected representative frames 124 are removed (i.e., they are no longer considered as representative frames 124) (808). The remaining, selected representative frame 124 is used to summarize the segment 102.

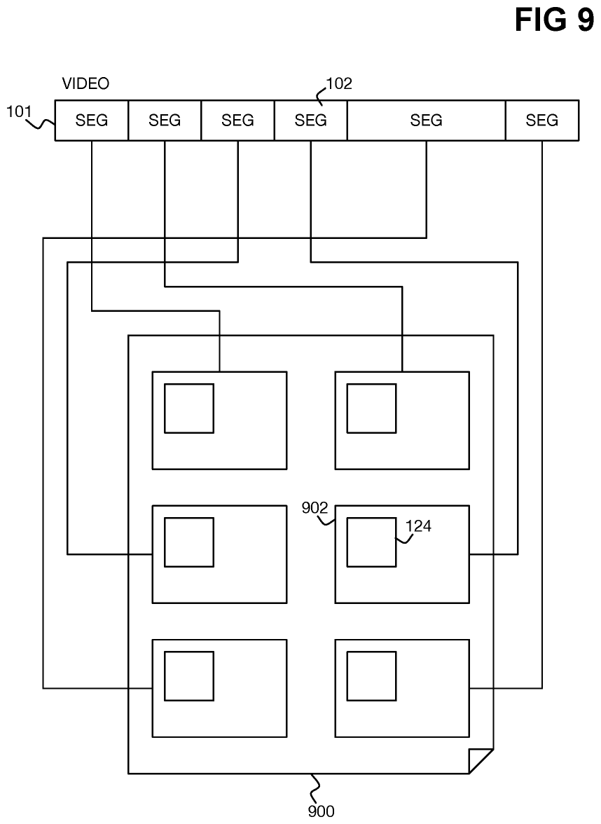

FIG. 9 shows an example summarization 900 of a video 101, including individual summarizations 902 of the segments 102 of the video 101. In the example, the summarization 900 is a non-video summarization in the form of one or more printed pages. Each printed page may include a maximum of Y summarizations 902 (where Y equals six in the example), which are ordered on the page in correspondence with the order of appearance of the segments 102 within the video 101. In the example, the summarizations 902 are equal in size, but in another implementation, they may have different sizes.

The summarization 902 of each video segment 102 includes the representative frame 124 that has been selected for that segment 102. A summarization 902 can include other information regarding its corresponding segment 102 as well. For example, a summarization 902 can include a summarization of the transcript of the speech of its corresponding segment 102.

In one implementation, then, a summarization 900 of a video 101 may be generated by first selecting a page template as to how summarizations 902 of the segments 102 of the video 101 are to appear on each page. A number of pages is instantiated to accommodate the number of video segments 102. The summarizations 902 of the segments 102 are generated, which can include just selecting the representative frame 124 of each segment 102. The summarizations 902 are then populated on the instantiated page or pages in order.

Other techniques can also be used to generate the summarization 900. For example, machine learning techniques may be employed to select an appropriate page template or templates, where different pages may employ different templates. The space afforded to summarizations 902 may differ in size on a given page. For example, a video segment 102 may be identified as the most important or most relevant segment 102 within the video 101, such that its summarization 902 is afforded the most prominent position and/or the most space on the first page.

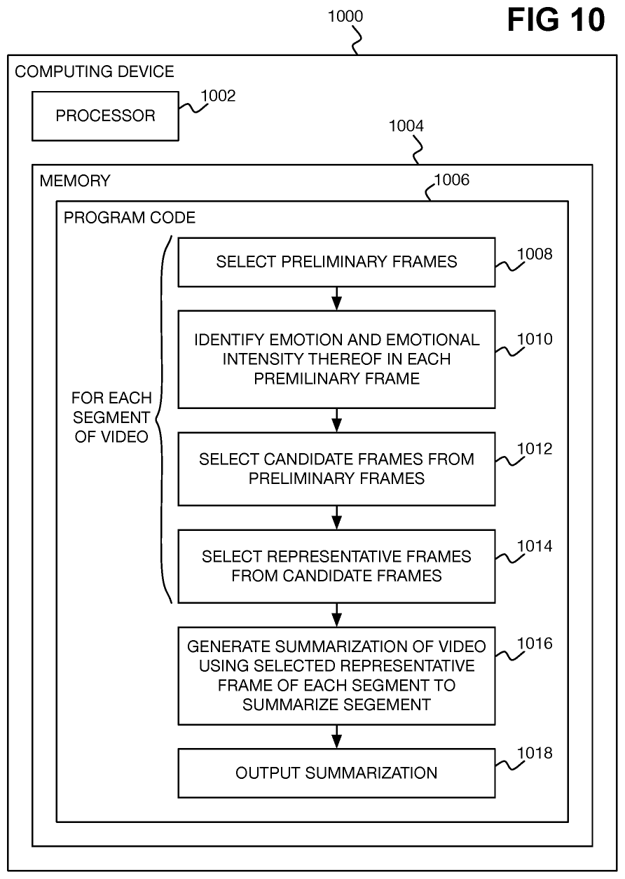

FIG. 10 shows an example computing device 1000. The computing device 1000 includes a processor 1002 and a memory 1004, which more generally is a non-transitory computer-readable data storage medium. The memory 1004 stores program code 1006 (i.e., instructions) executable by the processor 1002 to perform processing such as the process 100 and the methods 200, 400, 600, and 800 that have been described.

For instance, the processing can include, for each video segment 102 of the video 101, selecting preliminary frames 106 from the frames 104 (1008), followed by identifying the emotion 116 present in each frame 106 and the emotional intensity of that emotion 116 using a machine learning model (1010). The processing can include selecting candidate frames 120 from the preliminary frames 106 (1012).

The preliminary frames 106 are preliminary in that they are preliminary selected. The candidate frames 120 are candidates in that they are candidates for the representative frames 124. For each video segment 102, one or more representative frames 120 are therefore selected (1014), which may be output. A summarization of the video 101 is generated using the selected representative frame or frames 124 for the video segments 102 (1016). The summarization can then be output (1018), such as by printing if the summarization is a non-video summarization.

Techniques have been described for selecting a representative frame 124 for a video segment 102. The selection process can be at least partially performed without user interaction, and leverages machine learning to provide a technological improvement in such representative frame selection as an image processing technique. The selection process is performed in such a way that cannot be tractably performed manually by a user, and indeed in such a way that would not be performed if a user were to manually select a representative frame 124. The automatic nature of the selection process improves selection speed by employing machine learning and other image processing techniques, and moreover the described techniques have been found to result in a representative frame 124 that accurately represents the video segment 102.

We claim:

1. A non-transitory computer-readable data storage medium storing program code executable by a processor to perform processing comprising:
selecting a plurality of preliminary frames from a video segment;
identifying, for each preliminary frame, an emotion present in the preliminary frame and an emotional intensity of the emotion present in the preliminary frame, using a machine learning model;
selecting one or more candidate frames from the preliminary frames having the emotion that is present in a greatest number of the preliminary frames; and
selecting one or more representative frames for the video segment from the candidate frames based on the emotional intensity thereof.

2. The non-transitory computer-readable data storage medium of claim 1, wherein the processing further comprises:
outputting the representative frames for the video segment.

3. The non-transitory computer-readable data storage medium of claim 1, wherein the processing further comprises:
generating a summarization of a video including the video segment, the summarization including at least one of the representative frames to summarize the video segment.

4. The non-transitory computer-readable data storage medium of claim 3, wherein the processing further comprises:
outputting the summarization.

5. The non-transitory computer-readable data storage medium of claim 1, wherein selecting the preliminary frames from the video segment comprises:
selecting every m-th frame of the video segment as one of the preliminary frames.

6. The non-transitory computer-readable data storage medium of claim 1, wherein selecting the preliminary frames from the video segment comprises:
selecting a frame of the video segment every n-th length of elapsed run time of the video segment.

7. The non-transitory computer-readable data storage medium of claim 1, wherein selecting the preliminary frames from the video segment, for each preliminary frame other than a first preliminary frame, comprises:
selecting the preliminary frame as a frame of the video segment after a preceding preliminary frame that differs from the preceding preliminary frame by more than a threshold.

8. The non-transitory computer-readable data storage medium of claim 1, wherein the processing further comprises, for each preliminary frame other than a first preliminary frame and a last preliminary frame:
determining whether the preliminary frame differs from a preceding preliminary frame by more than a threshold; and
in response to determining that the preliminary frame does not differ from the preceding preliminary frame by more than the threshold, replacing the preliminary frame with a frame of the video segment between the preceding preliminary frame and a subsequent preliminary frame that differs from the preceding preliminary frame by more than a threshold.

9. The non-transitory computer-readable data storage medium of claim 1, wherein the processing further comprises:
clustering the preliminary frames into a plurality of clusters by similarity; and
in response to determining that a number of the clusters is less than a threshold:
removing one or more of the preliminary frames of the cluster having a largest number of the preliminary frames; and
replacing each removed preliminary frame with a frame of the video segment between a preceding preliminary frame and a subsequent preliminary frame that differs from the preceding preliminary frame by more than a threshold.

10. The non-transitory computer-readable data storage medium of claim 1, wherein selecting the representative frames for the video segment from the candidate frames comprises:
selecting, as the representative frames, the candidate frames that the emotional intensity of which is greater than a threshold.

11. The non-transitory computer-readable data storage medium of claim 1, wherein selecting the representative frames for the video segment from the candidate frames comprises:
selecting, as the representative frames, a threshold number or a threshold percentage of the candidate frames of which the emotional intensity of which is highest.

12. The non-transitory computer-readable data storage medium of claim 1, wherein the processing further comprises:
displaying the representative frames; and
receiving user selection of one of the displayed representative frames,
wherein the one of the displayed representative frames that has been user-selected is used within a summarization of a video including the video segmented to summarize the video segment.

13. A computing device comprising:
a processor; and
a memory storing instructions executable by the processor to:
identify, for each preliminary frame of a plurality of preliminary frames of a video segment, an emotion present in the preliminary frame and an emotional intensity of the emotion present in the preliminary frame, using a machine learning model;
select one or more candidate frames from the preliminary frames having the emotion that is present in a greatest number of the preliminary frames; and
select one or more representative frames for the video segment from the candidate frames based on the emotional intensity thereof.

14. The computing device of claim 13, wherein the instructions are executable by the processor to further:
generate a non-video summarization of the video including the video segment, the non-video summarization including at least one of the representative frames to summarize the video segment; and
printing the non-video summarization of the video.

15. The computing device of claim 13, wherein the instructions are executable by the processor to further select the preliminary frames by either:
selecting every m-th frame of the video segment as one of the preliminary frames;
select a frame of the video segment every n-th length of elapsed run time of the video segment; or
for every preliminary frame except for a first preliminary frame, select the preliminary frame as a frame of the video segment after a preceding preliminary frame that differs from the preceding preliminary frame by more than a threshold.

16. The computing device of claim 13, wherein the instructions are executable by the processor to further:
replacing each preliminary frame that is similar to another preliminary frame by more than a threshold with a different frame of the video segment.

17. The computing device of claim 13, wherein the instructions are executable by the processor to select the representative frames by either:
selecting, as the representative frames, the candidate frames that the emotional intensity of which is greater than a threshold; or
selecting, as the representative frames, a threshold number or a threshold percentage of the candidate frames of which the emotional intensity of which is highest.

18. The computing device of claim 13, wherein the instructions are executable by the processor to further:
display the representative frames; and
receive user selection of one of the displayed representative frames,
wherein the one of the displayed representative frames that has been user-selected is used within a summarization of a video including the video segmented to summarize the video segment.

19. A method comprising:
selecting, by a processor, a plurality of preliminary frames from a plurality of a frames of a video segment of a video;
applying, by the processor, n machine learning model to each preliminary frame to identify an emotion present in the preliminary frame and an emotional intensity of the emotion present in the preliminary frame;
selecting, by the processor, one or more candidate frames from the preliminary frames having the emotion that is present in a greatest number of the preliminary frames;
selecting, by the processor, one or more representative frames for the video segment from the candidate frames based on the emotional intensity thereof; and
outputting, by the processor, a non-video summarization of the video that includes at least one of the representative frames to summarize the video segment.

20. The method of claim 19, further comprising:
displaying, by the processor, the representative frames; and
receiving, by the processor, user selection of the at least one representative frames to summarize the video segment within the non-video summarization of the video.
